(19) United States
(12) Patent Application Publication
(10) Pub. No.: US 2014/0261854 A1
(43) Pub. Date: Sep. 18, 2014

(54) BAG IN BOX DISPENSING CONTAINER

(71) Applicant: ILLINOIS TOOL WORKS, INC., Glenview, IL (US)

(72) Inventors: John Nemec, Glenview, IL (US); Russell Waples, Glenview, IL (US)

(21) Appl. No.: 13/801,052

(22) Filed: Mar. 13, 2013

(51) Int. Cl. B67D 7/78

(52) U.S. Cl. CPC B67D 7/78
USPC 141/1; 222/105

(57) ABSTRACT

A bag-in-box dispensing system includes a box with a facing. A bag having a spout is placed with the box. A removable extension hose and a connector having snap wings for securing the extension hose to the spout is also provided. A bag-in-box dispensing system is also provided that includes a box with a facing configured with a removable flap. A bag with a spout containing a liquid inside said box is positioned within the box and a spout retracted under the removable flap. A removable extension hose is placed in the interior of the box for direct coupling to the spout or via a connector. A process of filling a vehicle DEF tank with diesel exhaust fluid (DEF) from the box is also provided.

### FIELD OF THE INVENTION

The present invention in general relates to liquid containers and in particular to a bag in box (BiB) dispensing container for holding and dispensing chemical liquids and vehicle fuels with a two position valve and extension hose.

### BACKGROUND OF THE INVENTION

Bag-in-box or BiB is a type of container for the storage and transportation of liquids. Bag-in-Box includes of a strong bladder (or plastic bag), usually made of several layers of metallized film or other plastics, seated inside a corrugated fiberboard box. The bag is supplied to the ‘filler’ as an empty pre made bag. The ‘filler’ then generally removes the tap, fills the bag and replaces the tap. The bags are available as singles for semi-automatic machines or as web bags, where the bags have perforations between each one. Webs of bags are used on automated filling systems where the bag is separated on line either before the bag is automatically filled or after.

Bag-in-Box technology is an economical and environmentally friendly delivery container for supplying liquids. BiB packaging is tamper evident and is made of recyclable materials. BiB packaging offers up to five times less waste than rigid containers, and empty packages collapse fully, saving space upon disposal. BiB packaging offers transport and storage advantages with an average forty percent improvement in storage, pallet space, and transport vehicle utilization.

The BiB has many commercial applications including the supply of syrup to soft drink fountains and to dispense bulk supplied condiments such as ketchup or mustard in the foodservice industry. BiB technology is also used to deliver chemicals, fuels, and automotive chemicals and fluids.

Despite the advantages offered by BiB containers and packaging, the dispensing and pouring of liquids into vehicle fluid or fuel tanks and system receptacles is often ergonomically stressful with undue loads being put on the arms and back of the user. Delivery of fluids to a vehicle poses unique problems of positioning a box in a precarious position on a vehicle and holding the box in position during fluid delivery.

Thus, there exists a need for BiB containers and packaging that offers improved delivery of liquids into tanks and fluid system while reducing ergonomic stresses on the user.

### SUMMARY OF THE INVENTION

A bag-in-box dispensing system includes a box with a facing. A bag having a spout is placed with the box. A removable extension hose and a connector having snap wings for securing the extension hose to the spout is also provided.

A bag-in-box dispensing system is also provided that includes a box with a facing configured with a removable flap. A bag with a spout containing a liquid inside said box is positioned within the box and a spout retracted under the removable flap. A removable extension hose is placed in the interior of the box for direct coupling to the spout or via a connector.

A process of filling a vehicle diesel exhaust fluid (DEF) tank with diesel exhaust fluid (DEF) includes the positioning of the box on a platform such that the box maintains a placement without additional human contact and proximal to the vehicle DEF tank. A proximal end of the removable extension hose is coupled to the spout and a distal end of the hose extends into the vehicle DEF tank. A binary valve associated with the spout is opened to allow the DEF to gravity feed into the vehicle DEF tank from the bag, which is not vented, within the box.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIGS. 1A-1C illustrate a perspective views and a sectioned view of an embodiment of the bag-in-box dispensing system;

FIG. 2 illustrates a top plan view of an embodiment of a die cut box blank for the bag-in-box dispensing system of FIG. 1 showing score lines, slots, and pull away tab;

FIGS. 3A-3C illustrate a series of instructional views of the outer wall protective flap and accessing the pullout spout and connecting the dispensing hose of FIG. 1C;

FIG. 4 illustrates a detailed plan view of an embodiment of the dispensing hose;

FIGS. 5A-5C illustrate plan views of an embodiment of a snap on connector for attaching the dispensing hose to the pullout spout as shown in FIG. 3C; and

FIGS. 6A-6B illustrate a front and side perspective view of an embodiment of the inventive two position pullout spout The detailed description explains the preferred embodiments of the invention.

### DESCRIPTION OF THE INVENTION

The present invention has utility as a bag-in-box (BiB) dispensing system for fluids, fuels, and chemicals for filling storage tanks and other vehicle systems such as hydraulic systems. Embodiments of the inventive BiB dispensing system improve the ergonomics of filling storage tanks and other vehicle systems by reducing stressful loads being put on the arms and back of a user that are common with traditional filling jugs and containers. Embodiments of the inventive BiB dispensing system incorporate a two position on-off spout with a snap on or screw on extension hose that allows the BiB containing the liquid to be dispensed to be positioned on a surface above the tank or vehicle system to be filled, thereby freeing the user from holding the BiB while fluids are being dispensed. The extension hose allows the fluids to be dispensed directly into a tank or system receptacle without wasteful spillage, and without the user having to hold the inventive BiB dispensing system and experience stress on their body.

With reference to the attached figures, an inventive BiB dispensing system is depicted generally at 10 in FIGS. 1A-1C. The BiB dispensing system 10 includes an outer box enclosure 12 having a dispensing wall 14 and a removable flap 16 with a perforated connection 15 to the dispensing wall 14. The cross section of the BiB dispensing system 10 of FIG. 1A taken along line A is shown in FIG. 1B, and illustrates a bladder or bag 18 for holding a liquid with a two position spout 22 and an extension hose 20 enclosed in the outer box 12. The bag 18 may be made of several layers of metallized film or of plastics, with the choice of material based on the liquid contents to be held; these substances illustratively include plastics such as low density polyethylene, and nylon. Liquids to be held may include chemicals, fuels, oils, brake fluid, power steering fluid, etc. In an embodiment the BiB dispensing system 10 holds diesel exhaust fluid (DEF), which is a urea based chemical reactant designed for use in selective catalytic reduction systems (SCR) to reduce nitrous oxide (NOx) emissions. It is noted that in recent diesel engine designs the DEF tank is separate from the diesel fuel tank. In specific embodiments the bag 18 is not a vented bag as competitor BiB offerings are, especially for gravity feeds. In other embodiments the bag 18 may be vented. FIG. 1C shows the two position spout 22 deployed and the extension hose 20 attached after flap 16 has been removed.

FIG. 2 illustrates a top plan view of an embodiment of a die cut box blank 12A for the bag-in-box dispensing system 10 of FIG. 1 showing score lines P, handle slots 24, and pull away tab 16. In an embodiment the box blank 12A is die cut from a corrugated cardboard sheet, or a composite sheet material. During assembly the die cut box blank 12A is folded along score lines P and a filled bag 18 is inserted prior to gluing the folded box blank 12A together to form outer box 12.

FIGS. 3A-3C illustrate a series of instructional views of the outer wall protective flap 16 and accessing the pullout spout 22 and connecting the dispensing hose 20 of FIG. 1. In order to access the contents of the BiB dispensing system 10, the tab 17 is pushed inward toward the interior of the outer box 12 to break the perforated seal 15, and the flap 16 is lifted up and removed from the face 14. With the flap 16 removed from the box 12, the hose 20 is removed from the interior of the box 12, and the spout 22 is pulled outward through the opening created by the removal of flap 16. With the spout 22 pulled out, the hose 20 is attached to the spout 22.

FIG. 4 illustrates a detailed view of an embodiment of the dispensing hose 20 showing articulations 28 that provide for flexibility and for extension of the hose 20. Intersecting ribs are provided at 27 in some embodiments. A dispensing hose 20 is formed of a variety of substances compatible with the contained fluid including those from which bag 18 is formed. It is appreciated that the length of the hose 20 is variable. In some embodiments, in which the fluid is DEF, the hose 20 has a length sufficient to allow the box 10 to be support on stand distinct from the vehicle to preclude the lifting and balancing that has characterized the prior art.

FIGS. 5A-5C illustrate views of an embodiment of a snap on connector 26 for attaching the dispensing hose 20 to the pullout spout 22 as shown in FIG. 3C. Snap wings 30 pressure fit engage and lock onto the spout 22 providing fluid communication between the spout 22 and a distal end of the hose 20. The spout 22 in certain embodiments has protrusions 34 (see FIGS. 6A and 6B) complementary to indents 31 in the snap wings 30 to facilitate certain engagement therebetween. The connector 26 affords several advantages over prior art connectors in having only two options of engagement: properly sealed fitting to the spout 22 or unsecured so as to prevent gapped engagement leakage; as well as a quick release upon completion of transfer from the box 10. It is appreciated that the dispensing hose 20 engages the spout 22 with complementary thread sets on each, a press fitting, bayonet fitting, or other conventional telescopic tubular joining structures.

FIGS. 6A and 6B illustrate a front and side perspective view, respectively of a specific embodiment of the inventive two position (off—on) pullout spout 22. In operation lever 32 is turned from the “off” position to an “on” position to start the flow of the liquid within the bag 18. A two-position only spout is found to avoid incidental spillage associated with handling or user error in failing to fully close a valve of the type common to the prior art.

In operation in the context of filling a vehicle DEF tank with diesel exhaust fluid (DEF) as the liquid, a process of usage includes the positioning of the box on a platform such that the box maintains a placement without additional human contact and proximal to the vehicle DEF tank. Avoidance of box balancing over a DEF tank opening or funnel per the prior art provided ergonomic advantages to an inventive process. A proximal end of the removable extension hose is coupled to the spout and a distal end of the hose extends into the vehicle DEF tank. A binary valve associated with the spout is opened to allow the DEF to gravity feed into the vehicle DEF tank from the non-vented bag within the box. The valve is then closed or the bag fully drained into the vehicle DEF tank. It is appreciated that a stable platform illustratively includes a truck step or a wheeled stand separate from the vehicle containing the vehicle DEF tank.

The foregoing description is illustrative of particular embodiments of the invention, but is not meant to be a limitation upon the practice thereof. The following claims, including all equivalents thereof, are intended to define the scope of the invention.

1. A bag-in-box dispensing system comprising:
a box with a facing;
a bag having a spout;
a removable extension hose; and
a connector having snap wings for securing said extension hose to said spout.

2. The system of claim 1 further comprising a liquid contained inside said box.

3. The system of claim 2 wherein said liquid is diesel exhaust fluid (DEF).

4. The system of claim 2 wherein said liquid is at least one of a chemical, fuel, oil, brake fluid, or power steering fluid.

5. The system of claim 1 wherein said spout retractable and concealable by a removable flap adhered to the facing.

6. The system of claim 1 wherein said bag is formed from plastic.

7. The system of claim 1 wherein said bag is formed from layers of metallized film.

8. The system of claim 1 wherein said spout has only two flow positions on and off.

9. The system of claim 1 said spout is placed in the interior of said box proximate to said facing.

10. The system of claim 1 wherein said hose is stored in said box.

11. A bag-in-box dispensing system comprising:
a box with a facing configured with a removable flap;
a bag with a spout containing a liquid inside said box, said spout retracted under said removable flap; and
a removable extension hose placed in the interior of said box, said removable extension hose having a proximal end adapted to engage said spout directly or via a connector.

12. The system of claim 11 wherein said liquid is diesel exhaust fluid (DEF).

13. The system of claim 11 wherein said bag is formed from plastic.

14. The system of claim 11 wherein said bag is formed from layers of metallized film.

15. The system of claim 11 wherein said spout has only two flow positions on and off.

16. The system of claim 11 wherein said connector has snap wings for securing said extension hose to said spout.

17. A process of filling a vehicle DEF tank with diesel exhaust fluid (DEF) comprising:
positioning the system of claim 1 on a platform such that the system maintains a placement without additional human contact and proximal to the vehicle DEF tank;
coupling a proximal end of said hose to said spout;
extending a distal end of said hose into the vehicle DEF tank; and
opening a binary valve associated with said spout to allow the DEF to gravity feed into the vehicle DEF tank from said box.

18. The process of claim 17 wherein said platform is a truck step or a wheeled stand separate from a vehicle containing the vehicle DEF tank.

19. The process of claim 17 wherein said coupling comprises a snap wing connector being secured between the proximal end of said hose and said spout.

20. The process of claim 17 further comprising extending said spout from said box prior to coupling to the proximal end of said hose to said spout.
